(19) United States
(12) Patent Application Publication
(10) Pub. No.: US 2020/0409929 A1
(43) Pub. Date: Dec. 31, 2020

(54) CLOUD-COUPLED CONNECTED SENSOR DATA AND TELEMATICS

(71) Applicant: RM ACQUISITION, LLC d/b/a RAND McNALLY, Skokie, IL (US)

(72) Inventors: Ravi Kodavarti, Chicago, IL (US); Yusuf Ozturk, Wilmette, IL (US)

(21) Appl. No.: 16/451,202

(22) Filed: Jun. 25, 2019

(51) Int. Cl. G06F 16/23; G06F 16/245

(52) U.S. Cl. CPC G06F 16/2365; G06F 16/245

(57) ABSTRACT

Asset management systems and methods are provided that may include a telematics device communicatively coupled to an asset. The telematics device may be configured to receive asset data, asset location data, and asset time data. The systems and methods may also include a sensor device configured to receive sensor data, sensor location data, and sensor time data. The systems and methods may further include a remote device communicatively coupled to the telematics device and the sensor device. The remote device may be configured to receive the asset data, the asset location data, the asset time data from the telematics device. The remote device may be configured to receive the sensor data, the sensor location data, and the sensor time data from the sensor device independent from the telematics device. The remote device may be configured to correlate the asset data with the sensor data based on the asset location data, the asset time data, the sensor location data, and the sensor time data. The remote device may be configured to compare the asset data with the sensor data and may verify the asset data based on the comparison of the asset data with the sensor data. The remote device may be configured to compare the asset data with the sensor data and may verify the sensor data based on the comparison of the asset data with the sensor data.

### TECHNICAL FIELD

The present disclosure generally relates to cloud-coupled connected sensor data and telematics. More particularly, the present disclosure relates to cloud-coupled connected sensor data and telematics data that is correlated based on geographic location and time data.

### BACKGROUND

Often times, various assets (e.g., cargo containers, trucks, planes, trains, etc.) within a fleet are dispersed over a large geographic area. Asset management systems are widely utilized to, for example, track asset geographic locations and to obtain asset status information.

Asset management systems may include vehicles having integral telematics devices (e.g., on-board vehicle bus connected devices), sensor devices (e.g., cameras, temperature sensors, door monitors, LIDAR systems, RADAR systems, etc.), and electronic logging devices (ELD). The asset management systems may, thereby, provide hours of service (HOS) reports, driver-vehicle inspection reports (DVIR), international fuel tax agreement (IFTA) reports, third party logistics (3PL) reporting, less than load (LTL) reporting, machine to machine (MTM) communication, accident investigation data, driver safety related data, etc.

In circumstances where a particular asset includes, for example, both a telematics device and a separate sensor device, a backend device of an asset management system may receive telematics device data independent of sensor device data, such that the telematics device data is not correlated or reconciled with the sensor device data.

Systems, methods, and apparatuses are needed that may independently receive telematics device data and sensor device data, and that may correlate the telematics device data with the sensor device data. Systems, methods, and apparatuses are also needed that may independently receive telematics device data and sensor device data, and that may reconcile the telematics device data with the sensor device data or reconcile the sensor device data with the telematics device data.

### SUMMARY

An asset management system may include a telematics device communicatively coupled to an asset. The telematics device may be configured to receive asset data, asset location data, and asset time data. The System may also include a sensor device configured to receive sensor data, sensor location data, and sensor time data. The System may further include a remote device communicatively coupled to the telematics device and the sensor device. The remote device may be configured to receive the asset data, the asset location data, the asset time data from the telematics device. The remote device may be configured to receive the sensor data, the sensor location data, and the sensor time data from the sensor device independent from the telematics device. The remote device may be configured to correlate the asset data with the sensor data based on the asset location data, the asset time data, the sensor location data, and the sensor time data.

In another embodiment, an asset management system may include a remote device configured to compare asset data with sensor data and may verify the asset data based on the comparison of the asset data with the sensor data. The remote device may be configured to compare the asset data with the sensor data and may verify the sensor data based on the comparison of the asset data with the sensor data.

In a further embodiment, a computer-implemented method of managing an asset may include receiving, at a processor of a telematics device, telematics device data in response to the processor of the telematics device executing a telematics device data receiving module. The telematics device data may be representative of: asset data, asset location data, and asset time data, from a communicatively coupled asset. The method may also include receiving, at a processor of a sensor device, sensor device data in response to the processor of the sensor device executing a sensor device data receiving module. The sensor device data may be representative of: sensor data, sensor location data, and sensor time data. The method may further include receiving, at a processor of a remote device, the telematics device data from the telematics device in response to the processor of the remote device executing a remote device telematics data receiving module. The remote device may be communicatively coupled to the telematics device. The method may yet further include receiving, at the processor of the remote device, the sensor device data from the sensor device, in response to the processor of the remote device executing a remote device sensor data receiving module. The remote device may be communicatively coupled to the sensor device. The sensor device data may be independent from the telematics device data. The method may also include correlating, using the processor of the remote device, the asset data with the sensor data, based on the asset location data, the asset time data, the sensor location data, and the sensor time data, in response to the processor of the remote device executing a data correlation module.

In yet a further embodiment, a computer-readable medium storing computer-readable instructions that, when executed by a processor, may cause the processor to manage an asset. The computer-readable medium may include a telematics device data receiving module that, when executed by a processor of a telematics device, may cause the processor of the telematics device to receive telematics device data from a communicatively coupled asset. The telematics device data may be representative of: asset data, asset location data, and asset time data. The computer-readable medium may also include a sensor device data receiving module that, when executed by a processor of a sensor device, may cause the processor of the sensor device to receive sensor device data from a sensor device. The sensor device data may be representative of: sensor data, sensor location data, and sensor time data. The computer-readable medium may further include a remote device telematics data receiving module that, when executed by a processor of a remote device, may cause the processor of the remote device to receive telematics device data from the telematics device. The remote device may be communicatively coupled to the telematics device. The computer-readable medium may yet further include a remote device sensor data receiving module that, when executed by the processor of the remote device, may cause the processor of the remote device to receive the sensor device data from the sensor device. The remote device may be communicatively coupled to the sensor device. The sensor device data may be independent from the telematics device data. The computer-readable medium may also include a data correlation module that, when executed by the processor of the remote device, may cause the processor of the remote device to correlate the asset data with the sensor data, based on the asset location data, the asset time data, the sensor location data, and the sensor time data, to generate correlated data.

### BRIEF DESCRIPTION OF THE DRAWINGS

FIG. 1 depicts an example high level block diagram of an asset management system;

FIG. 2A depicts an example first asset (e.g., a semi-truck), having a telematics device and a sensor device, coupled with an example second asset (e.g., a semi-truck trailer) having a sensor device;

FIG. 2B depicts an example asset (e.g., a semi-truck trailer) having a sensor device;

FIG. 3A depicts a block diagram of an example telematics device;

FIG. 3B depicts a flow diagram for an example method of operating the example telematics device of FIG. 3A;

FIG. 4A depicts a block diagram of an example sensor device;

FIG. 4B depicts a flow diagram for an example method of operating the example sensor device of FIG. 4A;

FIG. 5A depicts a block diagram of an example remote device;

FIG. 5B depicts a flow diagram for an example method of operating the example remote device of FIG. 5A;

FIG. 6A depicts a block diagram of an example backend device; and

FIG. 6B depicts a flow diagram for an example method of operating the example backend device of FIG. 6A.

### DETAIL DESCRIPTION

Asset management systems, and apparatuses and methods for use within asset management systems, are provided that may include at least one remote device (e.g., a cloud-coupled computing device), and at least one asset having a telematics device and at least one sensor device. As described in detail herein, the telematics device(s) may communicate telematics device data to the remote device(s) and the sensor device(s) may communicate sensor device data to the remote device(s).

The telematics device data may include, for example, asset data, asset location data, and asset time data. The sensor device data may include, for example, sensor data, sensor device location data, and sensor device date/time data. Telematics device data may be communicated to any given remote device independent of sensor device data.

A remote device may correlate asset data with sensor data based on a comparison of asset location data with sensor device location data and asset time data with sensor device time data. For example, when the remote device determines that the asset location data matches the sensor device location data and that the asset time data matches the sensor device time data, the remote device may correlate the asset data with the sensor data (i.e., the remote device may determine that the telematics device and the sensor device are associated with the same asset, or that the telematics device was at the same location as the sensor device at a time when the asset data and the sensor data were received by the respective device). Furthermore, when the remote device determines that the asset location data matches the sensor device location data and that the asset time data matches the sensor device time data, the remote device may reconcile (or verify) the asset data with the sensor data, or may reconcile (or verify) the sensor data with the asset data.

As a specific example, an asset (e.g., a truck) may include a sensor device having at least one sensor (e.g., a digital image sensor) and a telematics device. The telematics device may receive asset data (e.g., odometer data, engine revolutions-per-minute (RPM) data, etc.) from, for example, a body controller of the truck along with asset location data and asset time data. The sensor device may receive digital image data from the digital image sensor along with sensor device location data and sensor device time data. The telematics device data and the sensor device data may be, for example, independently transmitted to a remote device (e.g., a cloud-coupled computer). When the cloud-coupled computer determines that the asset location data matches the sensor device location data and that the asset time data matches the sensor device time data, the cloud-coupled computer may correlate the asset data with the digital image sensor data (i.e., the cloud-coupled computer may determine that the telematics device and the sensor device are associated with the truck, or that the truck was at the same location as another asset having the sensor device when the asset data and the sensor data were received by the respective device).

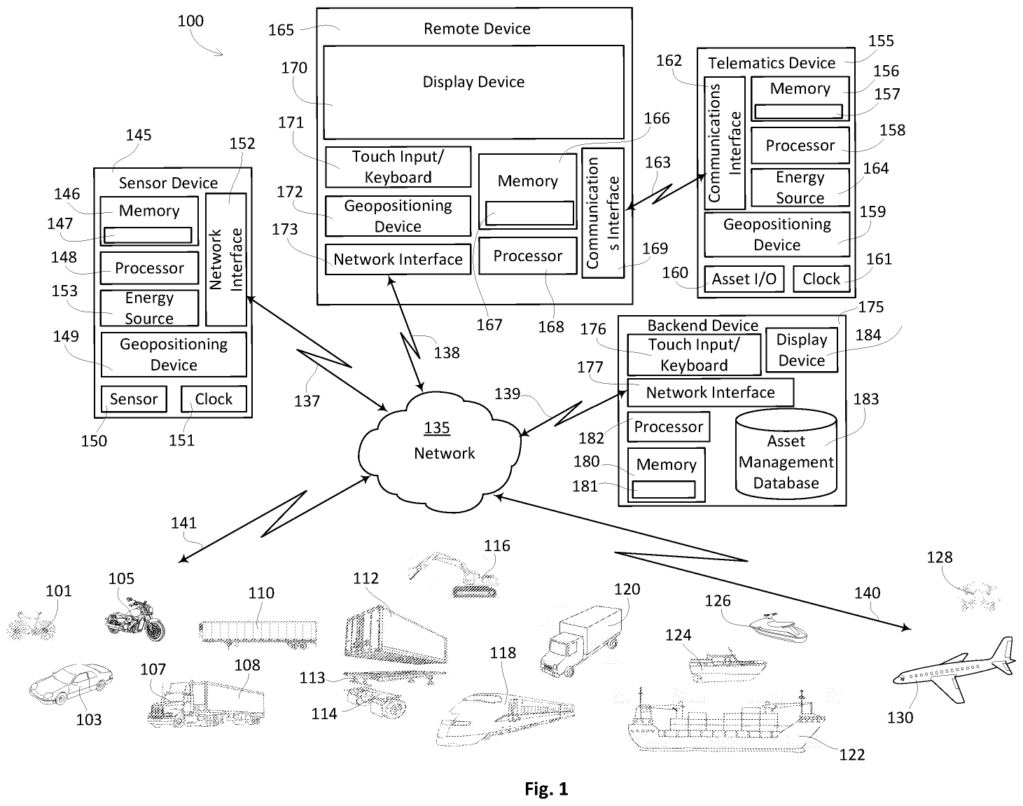

Turning to FIG. 1, an asset management system 100 may include at least one telematics device 155 and at least one sensor device 145 communicatively coupled to at least one remote device 165 (e.g., a cloud-coupled connected device) via a network 135 (e.g., a cloud-based network). The asset management system 100 may also include at least one backend device 175. While, for purposes of clarity, only a single telematics device 155, a single sensor device 145, a single remote device 165, and a single backend device 175 are shown in FIG. 1, an asset management system 100 may include any number of telematics devices 155, sensor devices 145, remote devices 165, and backend devices 175. As an example, any one of the assets 101-130 may include at least one sensor device 145 and/or at least one telematics device 155. Further details of the asset management system 100, and more particularly, the telematics device 155, the sensor device 145, the remote device 165, and the backend device 175 are provided herein.

The network 135 may include various communications paths 137-141 that may include a dedicated network interface, a proprietary network interface, a wide area network interface, a local area network interface, a WiFi network interface, a Bluetooth network interface, a cellular telephone network interface, a satellite network interface, a sub-combination thereof, or a combination thereof. Similarly, the communications path 163 may include a dedicated network interface, a proprietary network interface, a wide area network interface, a local area network interface, a WiFi network interface, a Bluetooth network interface, a cellular telephone network interface, a satellite network interface, a sub-combination thereof, or a combination thereof. Any given path 137-141, 163 may be independent of any other path.

An asset 101-130 may be, for example, a bicycle 101, a car 103, a van (not shown in FIG. 1), a bus (not shown in FIG. 1), a truck 120, a truck and trailer 107, 108, a refrigerated trailer 110, a cargo container 112, a cargo container chassis 113, a cargo container dolly 114, construction equipment 116 (e.g., a track hoe, a back hoe, a frontend loader, a compactor, a crane, a dump truck, a bulldozer, a crane, a mobile pan, etc.), a jet ski 126, a motorcycle 105, a snowmobile (not shown in FIG. 1), a golf cart (not shown in FIG. 1), an off-road vehicle (not shown in FIG. 1), a motorhome (not shown in FIG. 1), a drone 128, a robot (not shown in FIG. 1), a mail delivery vehicle (not shown in FIG. 1), a FedEx delivery vehicle (not shown in FIG. 1), a UPS (not shown in FIG. 1), a DHL (not shown in FIG. 1), a bus (not shown in FIG. 1), an airplane 130, a helicopter (not shown in FIG. 1), an emergency vehicle (e.g., a police car, an ambulance, a fire truck, etc.) (not shown in FIG. 1), a boat 124, a cargo ship 122, a train 118, etc. An asset may be manually operated (e.g., locally, remotely, etc.) and/or autonomously operated.

A sensor device 145 may include a processor 148, a memory 146 storing a module 147, a geopositioning device 149, at least one sensor 150, a clock 151, a network interface 152, and an energy source 153. The module 147 may be, for example, stored on the memory 146, as a set of computer-readable instructions that, when executed by the processor 148, may cause the processor 148 to operate the sensor device 145 (e.g., cause the processor 148 to receive sensor data from the at least one sensor 150, sensor device location data from the geopositioning device 149, and sensor device time data from the clock 151, and to transmit the sensor device data to a remote device 165 and/or a backend device 175 via the network interface 152). The sensor device location data may be representative of, for example, a sensor device geographic location, a sensor device longitudinal location, a sensor device latitudinal location, a sensor device altitudinal location, any sub-combination thereof, or a combination thereof. The sensor device time data may be representative of, for example, a sensor device time zone, a sensor device time of day, a sensor device day of calendar year, a sensor device calendar year, any sub-combination thereof, or a combination thereof.

A full length cargo sensor 150 may be, for example, integrated with an asset tracking device to detect the presence or absence of cargo inside standard full-length trailers, providing greater asset visibility and security. A full length cargo sensor may include a sensing range of up to 53 feet. A full length cargo sensor 150 may send alerts if a change in load status occurs or if the sensor is damaged or removed. As part of a comprehensive trailer tracking solution, a full length cargo sensor 150 may enable fleet operators to quickly identify empty and loaded trailers, optimize turn time, detect cargo theft and more. A door sensor 150 may detect if the trailer or container door is open or closed beyond set parameters or while in route, providing enhanced security and operational efficiency. A door sensor may report a rapid number of open and close events or if the asset is outside a pre-determined geofence, helping fleet owners improve asset safety and security.

A solar-powered sensor device 145 may be, for example, configured as an all-in-one trailer and container tracking solution and may integrate cargo sensors. Ideally suited for large-scale deployments, a solar-powered sensor device may be installed without operational disruption. A solar-powered sensor device 145 may be incorporated on any trailer or container asset type and in any orientation. A solar-powered sensor device 145 may enable remote asset management and cargo status detection capabilities with minimum wiring.

A side door sensor 150 may seamlessly integrate into an asset tracking solution, detecting when a side door of, for example, a vehicle or trailer is opened or closed outside set parameters, such as location or temperature, in order to help operators protect cargo against temperature deviations and theft.

A temperature sensor 150 may be integrated into, for example, a cold chain monitoring system to ensure the integrity of temperature-sensitive cargoes such as refrigerated or frozen foods and pharmaceuticals as they move along the supply chain. A temperature sensor may operate in extreme temperatures and environments.

A fuel sensor 150 may monitor vehicle and/or trailer fuel volume. For example, a fuel sensor may provide operational and management data to reefer monitoring applications. The fuel sensor can immediately detect and report rapid loss of fuel to provide a significant deterrent against fuel theft and pilferage. The sensor is installed in the reefer fuel tank and typical installation is completed in less than an hour with an easy-to-use configuration tool.

As an alternative to the module 147 being stored on the memory 146 as a set of computer-readable instructions, the module 147 may be embodied entirely as hardware (e.g., electrical circuitry with discrete components, logic circuits, a field programmable gate array (FPGA), an application specific integrated circuit (ASIC), dedicated electrical circuits, etc.). The energy source 153 may be, for example, a battery, a photovoltaic device, a capacitor, a fuel cell, a electrical generator, etc., any sub-combination thereof, or a combination thereof. The network interface 152 may be, for example, a dedicated network interface, a proprietary network interface, a wide area network interface, a local area network interface, a WiFi network interface, a Bluetooth network interface, a cellular telephone network interface, a satellite network interface, a sub-combination thereof, or a combination thereof.

The sensor device 145 may include, for example, at least one sensor 150 selected from at least one of: a digital image sensor, a video camera, a door position sensor, a fuel level sensor, a temperature sensor, a temperature control unit status sensor, a humidity sensor, a humidity control unit status sensor, a moisture sensor, a moisture control unit status sensor, a pressure sensor, a pressure control unit status sensor, a light detection and ranging (LIDAR) sensor, a radar sensor, an ultra-sonic sensor, a weight sensor, a distance sensor, an occupancy sensor, a length sensor, an occupancy sensor, or a light sensor. A sensor 150 may be configured as a radio frequency identification tag, a radio frequency identification tag reader, a weight sensor (I, a strain gage sensor on an asset suspension), a tire pressure sensor, a tire height sensor, an impact sensor (e.g., a cargo impact sensor, an accelerometer, etc.), a moisture (humidity) sensor, an altimeter sensor, etc.

A telematics device 155 may include a processor 158, a memory 156 storing a module 157, a geopositioning device 159, at least one asset I/O 160, a clock 161, a communications interface 162, and at least one energy source 164. The module 157 may be, for example, stored on the memory 156, as a set of computer-readable instructions that, when executed by the processor 158, may cause the processor 158 to operate the telematics device 155 (e.g., cause the processor 158 to receive asset data from the at least one asset I/O 160, asset location data from the geopositioning device 159, and asset time data from the clock 161, and to transmit the telematics device data to a remote device 165 and/or a backend device 175 via the communications interface 162). The asset location data may be representative of, for example, an asset geographic location, an asset longitudinal location, an asset latitudinal location, an asset altitudinal location, any sub-combination thereof, or a combination thereof. The asset time data may be representative of, for example, an asset time zone, an asset time of day, an asset day of calendar year, an asset calendar year, any sub-combination thereof, or a combination thereof.

As an alternative to the module 157 being stored on the memory 156 as a set of computer-readable instructions, the module 157 may be embodied entirely as hardware (e.g., electrical circuitry with discrete components, logic circuits, a field programmable gate array (FPGA), an application specific integrated circuit (ASIC), dedicated electrical circuits, etc.). The energy source 164 may be, for example, a battery, a photovoltaic device, a capacitor, a fuel cell, a electrical generator, etc., any sub-combination thereof, or a combination thereof. The communications interface 162 may be, for example, a dedicated network interface, a proprietary network interface, a wide area network interface, a local area network interface, a WiFi network interface, a Bluetooth network interface, a cellular telephone network interface, a satellite network interface, a sub-combination thereof, or a combination thereof.

The telematics device 155 may, for example, collect asset data from an associated asset 101-130 via asset I/O 160. The asset data may be representative of, for example, at least one of: asset body controller data, asset engine control unit history, asset air supply pressure, asset fuel consumption, asset trip information, asset speed, asset cruise control status, asset manual operation mode status, asset autonomous operation mode status, asset engine cooling fan drive status, asset wheel speed, asset service indication, asset transmission control unit history, asset body control unit history, asset driver door status indicator, asset passenger door indicator, asset engine oil level, asset engine oil pressure, asset engine idle operation, asset turbocharger status, asset air start pressure, asset steering wheel angle, an asset accelerometer, asset pitch, asset yaw data, asset travel distance, asset idle shutdown, asset engine hours, asset engine revolutions per minute, asset operation hours, asset direction heading, asset weight, asset cruise control speed setting, asset engine temperature, asset power takeoff information, asset fuel economy, asset tire condition, asset ambient conditions, asset inlet air condition, asset exhaust condition, asset electrical power condition, asset transmission fluid level, asset transmission fluid pressure, asset brake information, asset engine coolant level, asset engine coolant pressure, asset odometer reading, asset identification number, asset crankcase pressure, asset barometric pressure, asset interior temperature, asset air inlet temperature, road surface temperature, asset particulate trap inlet pressure, asset boost pressure, asset intake manifold temperature, asset air inlet pressure, asset air filter differential pressure, asset exhaust gas temperature, asset coolant filter differential pressure, asset instantaneous fuel economy, asset average fuel economy, asset fuel temperature, asset turbo oil temperature, asset total fuel use, asset trip fuel use, asset injector metering rail pressure, asset injection control pressure, asset percent fan speed, asset engine-percent torque demand, asset actual engine-percent torque, asset accelerator position, asset percent load at current speed, asset brake position, asset clutch position, or asset water in fuel.

A remote device 165 may include a processor 168, a memory 166 storing a module 167, a geopositioning device 172, a display device 170, a touch input/keyboard 171, a communications interface 169, and a network interface 173. The module 167 may be, for example, stored on the memory 166, as a set of computer-readable instructions that, when executed by the processor 168, may cause the processor 168 to operate the remote device 165 (e.g., cause the processor 168 to receive telematics device data from at least telematics device 155 via the communications interface 169 and/or sensor device data from at least one sensor device 145 via the network interface 173, correlate asset data with sensor data, and to transmit the correlated data to a backend device 175 via the network interface 173). As an alternative to the module 167 being stored on the memory 166 as a set of computer-readable instructions, the module 167 may be embodied entirely as hardware (e.g., electrical circuitry with discrete components, logic circuits, a field programmable gate array (FPGA), an application specific integrated circuit (ASIC), dedicated electrical circuits, etc.). The network interface 173 and the communications interface 169 may be, for example, a dedicated network interface, a proprietary network interface, a wide area network interface, a local area network interface, a WiFi network interface, a Bluetooth network interface, a cellular telephone network interface, a satellite network interface, a sub-combination thereof, or a combination thereof.

A backend device 175 may include a processor 182, a memory 180 storing a module 181, a display device 184, a touch input/keyboard 176, an asset management database 183, and a network interface 175. The module 181 may be, for example, stored on the memory 180, as a set of computer-readable instructions that, when executed by the processor 182, may cause the processor 182 to operate the backend device 175 (e.g., cause the processor 182 to receive telematics device data from at least telematics device 155, receive sensor device data from at least one sensor device 145, and receive correlate data from at least one remote device 165 via the network interface 177). As an alternative to the module 181 being stored on the memory 180 as a set of computer-readable instructions, the module 181 may be embodied entirely as hardware (e.g., electrical circuitry with discrete components, logic circuits, a field programmable gate array (FPGA), an application specific integrated circuit (ASIC), dedicated electrical circuits, etc.). The network interface 177 may be, for example, a dedicated network interface, a proprietary network interface, a wide area network interface, a local area network interface, a WiFi network interface, a Bluetooth network interface, a cellular telephone network interface, a satellite network interface, a sub-combination thereof, or a combination thereof.

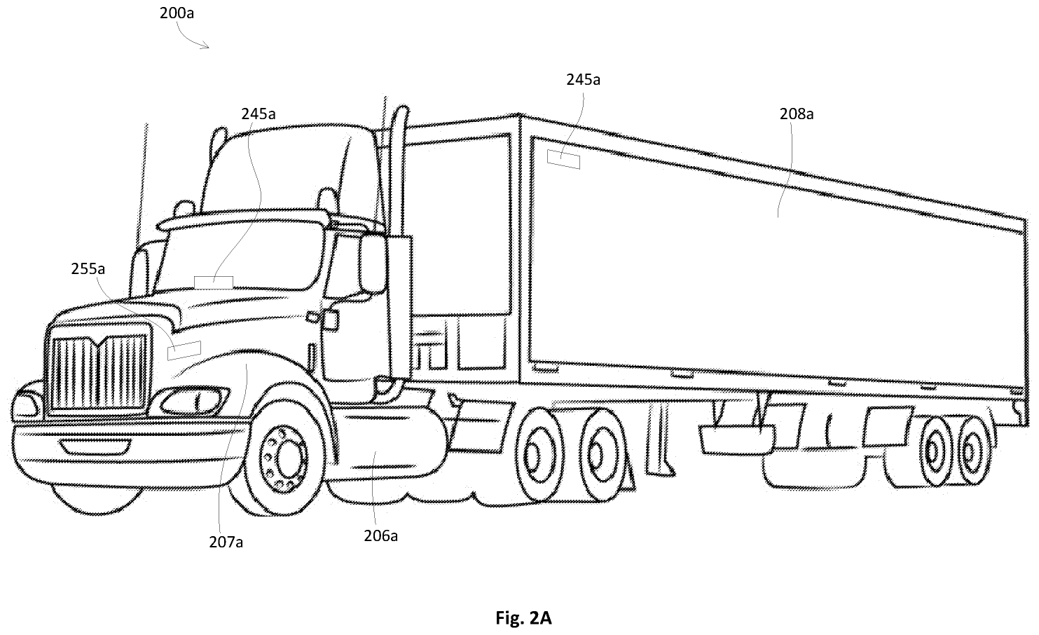

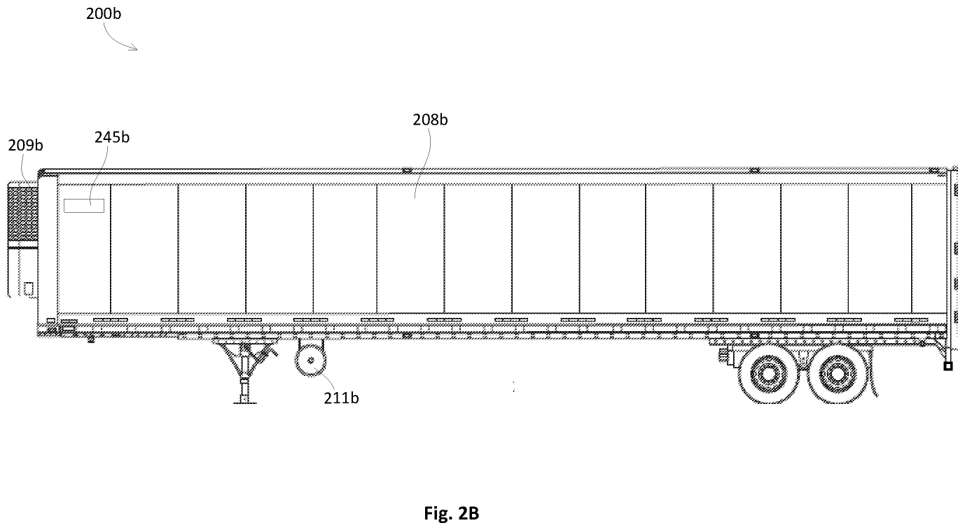

With reference to FIG. 2A, an asset 200a may include a semi-truck 207a and a trailer 208a. The semi-truck 207a may include a first sensor device 245a, a telematics device 255a, and a fuel tank 206a. The first sensor device 245a may be similar to, for example, the sensor device 145 of FIG. 1, and may include a forward facing digital image sensor and a rearward facing digital image sensor. The telematics device 255a may be similar to, for example, the telematics device 155 of FIG. 1. The trailer 208a may include a second sensor device 245a. The second sensor device 245a may be similar to, for example, the sensor device 145 of FIG. 1, and may include a door position sensor, a tire pressure monitor, a tire height sensor, a cargo sensor, and an impact sensor (e.g., an accelerometer, a pressure sensor, etc.).

Turning to FIG. 2B, an asset 200b may include a reefer 208b having a sensor device 245b, an atmosphere control unit 209b (e.g., a refrigeration unit, a heating unit, a ventilation unit, dehumidifier, a humidifier, etc.), and a fuel tank 211b. The sensor device 245b may be similar to the sensor device 145 of FIG. 1, or the first or second sensor devices 245a of FIG. 2A. In any event, the sensor device 245b may include a temperature sensor, a fuel tank level sensor, and an atmosphere control unit output. The sensor device 245b may, for example, automatically control the atmosphere control unit, based upon the temperature sensor and/or the fuel tank level sensor, via the atmosphere control unit output. Additionally, or alternatively, the sensor device 245b may receive a remote control signal from, for example, a backend unit 175, and may control the atmosphere control unit, based upon the remote control signal, via the atmosphere control unit output.

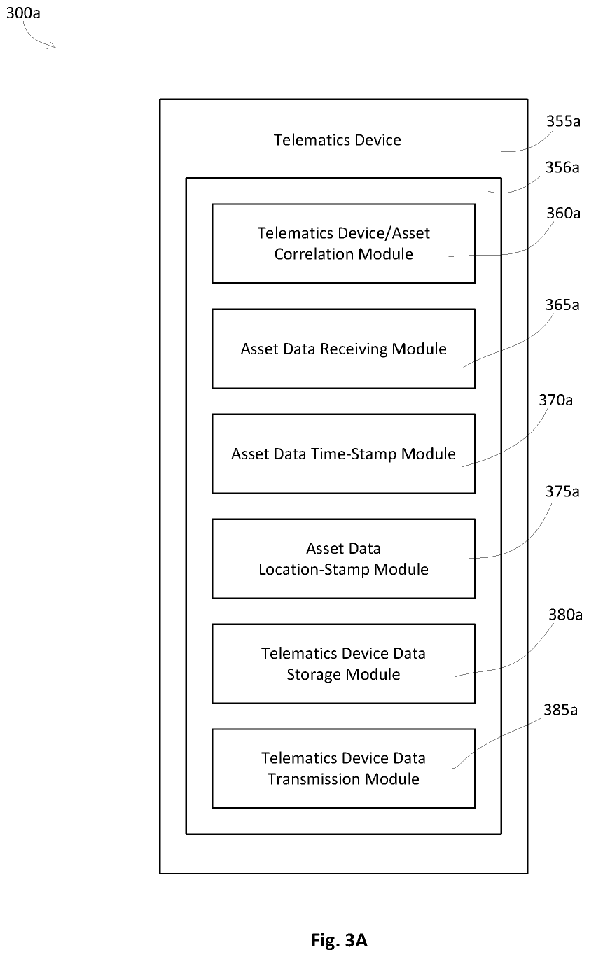

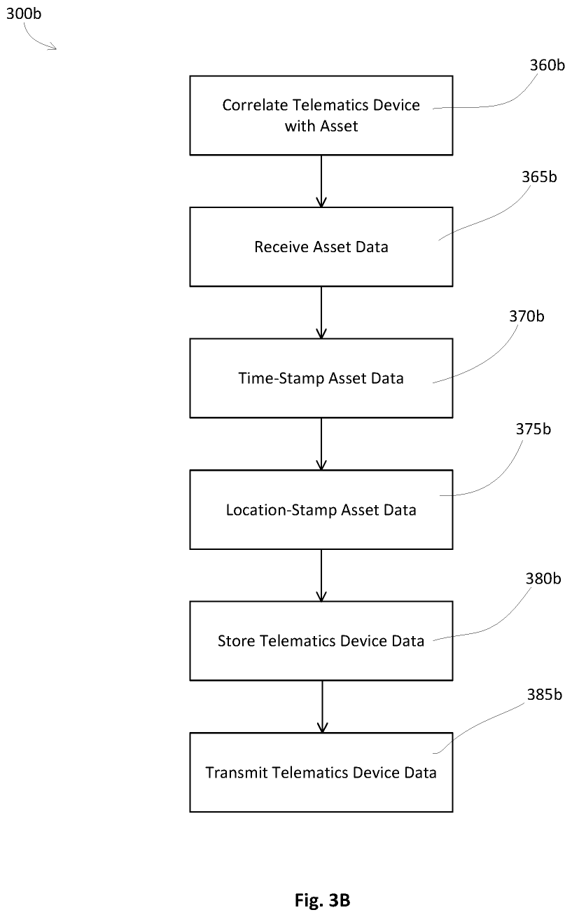

With reference to FIGS. 3A and 3B, an asset management system 300a, 300b may include a telematics device 355a. The asset management system 300a, 300b may be similar to, for example, the asset management system 100 of FIG. 1. The telematics device 355a may be similar to, for example, the telematics device 155 of FIG. 1 or the telematics device 255a of FIG. 2A. In any event, the telematics device 355a may include a telematics device/asset correlation module 360a, asset data receiving module 365a, an asset data time-stamp module 370a, an asset data location-stamp module 380a, a telematics device data storage module 380a, and a telematics device data transmission module 385a stored on a memory 356a as, for example, a set of computer-readable instructions. The modules 360a-385a may be similar to, for example, the module 157 of FIG. 1. The memory 356a may be similar to, for example, memory 156 of FIG. 1.

As an alternative to the modules 360a-385a being stored on the memory 356a as a set of computer-readable instructions, any one of, any sub-combination of, or all of the modules 360a-385a may be embodied entirely as hardware (e.g., electrical circuitry with discrete components, logic circuits, a field programmable gate array (FPGA), an application specific integrated circuit (ASIC), dedicated electrical circuits, etc.).

With further reference to FIG. 3B, a processor (e.g., processor 158 of FIG. 1) may execute the telematics device/asset correlation module 360a to, for example, cause the processor 158 to correlate at least one telematics device (e.g., telematics device 355a) with a particular asset (e.g., any one of the assets 101-130 of FIG. 1) (block 360b). The processor 158 may execute the asset data receiving module 365a to, for example, cause the processor 158 to receive asset data from, for example, at least one asset I/O (e.g., asset I/O 160 of FIG. 1) (block 365b).

The processor 158 may execute the asset data time-stamp module 370a to, for example, cause the processor 158 to time-stamp the asset data (block 370b). The processor 158 may execute the asset data location-stamp module 375a to location-stamp the asset data (block 375b). The processor 158 may execute the telematics device data storage module 380a to, for example, cause the processor 158 to store the asset data, the time-stamped asset data, and the location-stamped asset data (i.e., the telematics device data) in a memory (e.g., memory 356a) (block 380b). The processor 158 may execute the telematics device data transmission module 385a to, for example, cause the processor 158 to transmit the telematics device data to a remote device (e.g., remote device 165 of FIG. 1) and/or a backend device (e.g., backend device 175 of FIG. 1) (block 380b).

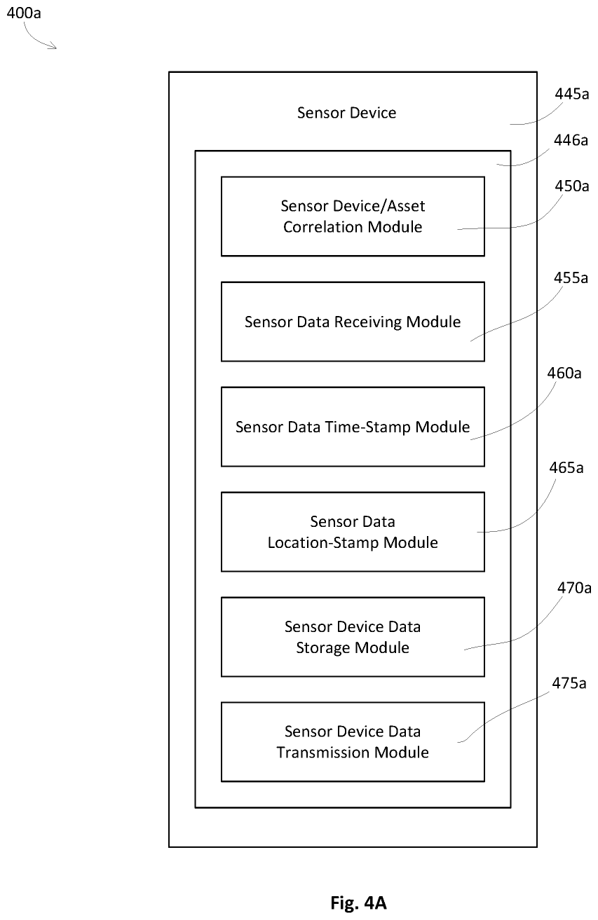

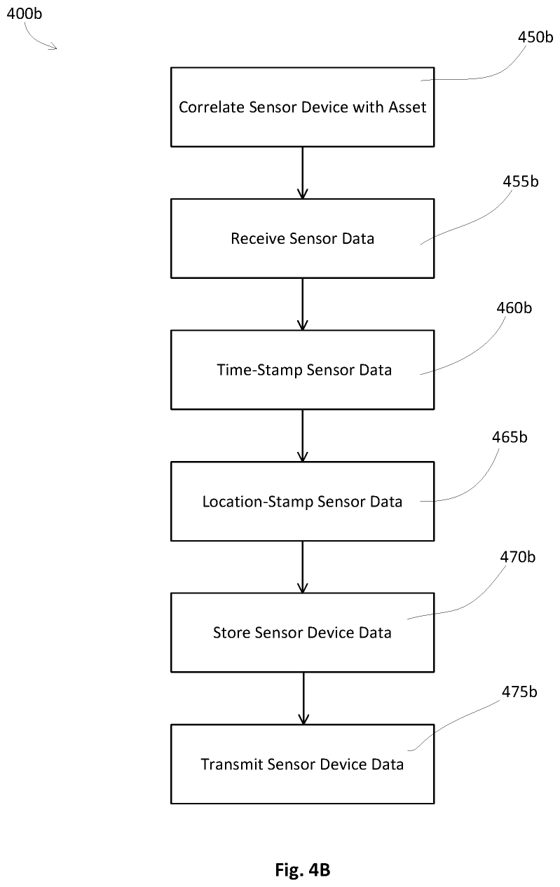

Turning to FIGS. 4A and 4B, an asset management system 400a, 400b may include a sensor device 445a. The asset management system 400a, 400b may be similar to, for example, the asset management system 100 of FIG. 1. The sensor device 445a may be similar to, for example, the sensor device 145 of FIG. 1, the sensor devices 245a of FIG. 2A, or the sensor device 245b of FIG. 2B. In any event, the sensor device 4455a may include sensor device/asset correlation module 450a, a sensor data receiving module 455a, a sensor data time-stamp module 460a, a sensor data location-stamp module 465a, a sensor device data storage module 470a, and a sensor device data transmission module 475a stored on a memory 446a as, for example, a set of computer-readable instructions. The modules 450a-475a may be similar to, for example, the module 147 of FIG. 1. The memory 446a may be similar to, for example, memory 146 of FIG. 1.

As an alternative to the modules 450a-475a being stored on the memory 446a as a set of computer-readable instructions, any one of, any sub-combination of, or all of the modules 450a-475a may be embodied entirely as hardware (e.g., electrical circuitry with discrete components, logic circuits, a field programmable gate array (FPGA), an application specific integrated circuit (ASIC), dedicated electrical circuits, etc.).

With further reference to FIG. 4B, a processor (e.g., processor 148 of FIG. 1) may execute the sensor device/asset correlation module 450a to, for example, cause the processor 148 to correlate at least one sensor device (e.g., sensor device 445a) with a particular asset (e.g., any one of the assets 101-130 of FIG. 1) (block 450b). The processor 148 may execute the sensor data receiving module 455a to, for example, cause the processor 148 to receive sensor data from at least one sensor (e.g., sensor 150 of FIG. 1) (block 455b).

The processor 148 may execute the sensor data time-stamp module 460a to, for example, cause the processor 148 to time-stamp the sensor data (block 460b). The processor 148 may execute the sensor data location-stamp module 465a to, for example, cause the processor 148 to location-stamp the sensor data (block 465b). The processor 148 may execute the sensor device data storage module 470a to, for example, cause the processor 148 to store the sensor device data (i.e., the sensor data, the time-stamped sensor data, and the location-stamped sensor data) in a memory (e.g., memory 146 of FIG. 1) (block 470b). The processor 148 may execute the sensor device data transmission module 475a to, for example, cause the processor 148 to transmit the sensor device data to a remote device (e.g., remote device 165 of FIG. 1) and/or a backend device (e.g., backend device 175 of FIG. 1) (block 475b).

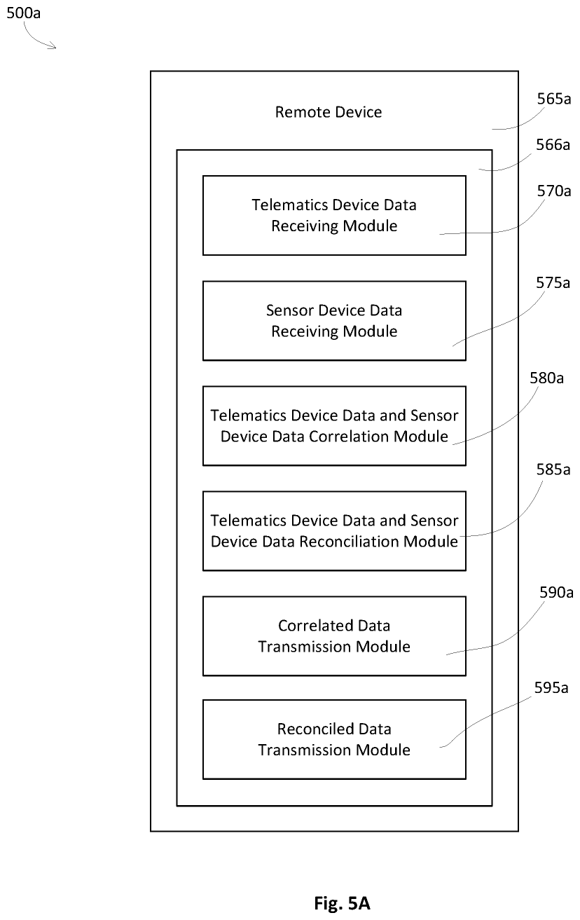

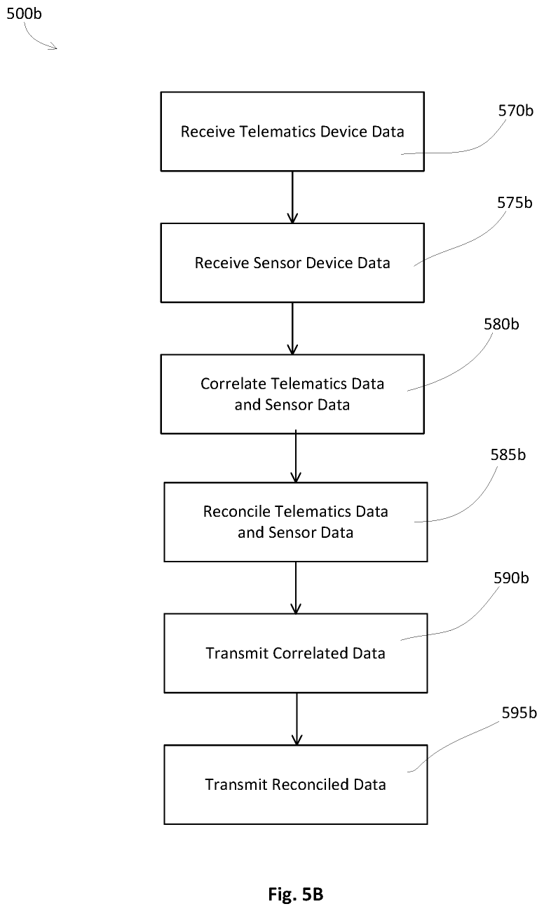

With reference to FIGS. 5A and 5B, an asset management system 500a, 500b may include a remote device 565a. The asset management system 500a, 500b may be similar to, for example, the asset management system 100 of FIG. 1. The remote device 565a may be similar to, for example, the remote device 165 of FIG. 1. In any event, the remote device 565a may include a telematics device data receiving module 570a, a sensor device data receiving module 575a, a telematics device data and sensor device data correlation module 580a, a telematics device data and sensor device data reconciliation module 585a, a correlated data transmission module 590a, and a reconciled data transmission module stored on a memory 566a as, for example, a set of computer-readable instructions. The modules 570a-595a may be similar to, for example, the module 167 of FIG. 1. The memory 566a may be similar to, for example, memory 166 of FIG. 1.

As an alternative to the modules 570a-595a being stored on the memory 566a as a set of computer-readable instructions, any one of, any sub-combination of, or all of the modules 570a-595a may be embodied entirely as hardware (e.g., electrical circuitry with discrete components, logic circuits, a field programmable gate array (FPGA), an application specific integrated circuit (ASIC), dedicated electrical circuits, etc.).

With further reference to FIG. 5B, a processor (e.g., processor 168 of FIG. 1) may execute the telematics device data receiving module 570a to, for example, cause the processor 168 to receive telematics device data from a telematics device (e.g., telematics device 155 of FIG. 1, telematics device 255a of FIG. 2A, or telematics device 355a of FIG. 3A) (block 570b). The processor 168 may execute the sensor device data receiving module 575a to, for example, cause the processor 168 to receive sensor device data from a sensor device (e.g., sensor device 145 of FIG. 1, sensor device 245a of FIG. 2A, sensor device 245b of FIG. 2B, or sensor device 445a of FIG. 4A) (block 575b).

The processor 168 may execute the telematics device data and sensor device data correlation module 580a to, for example, cause the processor 168 to correlate the asset data and the sensor data (block 580b). For example, when the remote device determines that the asset location data matches the sensor device location data and that the asset time data matches the sensor device time data, the remote device may correlate the asset data with the sensor data (i.e., the remote device may determine that the telematics device and the sensor device are associated with the same asset, or that the telematics device was at the same location as the sensor device at a time when the asset data and the sensor data were received by the respective device).

The processor 168 may execute the telematics device data and sensor device data reconciliation module 585a to, for example, cause the processor 168 to reconcile the asset data with the sensor data and/or reconcile the sensor data with the asset data (block 585b). For example, when the remote device determines that the asset location data matches the sensor device location data and that the asset time data matches the sensor device time data, the remote device may reconcile (or verify) the asset data with the sensor data, or may reconcile (or verify) the sensor data with the asset data.

The processor 168 may execute the correlated data transmission module 590a to, for example, cause the processor 168 to transmit the correlated data to a backend device (e.g., backend device 175 of FIG. 1) (block 590b). The processor 168 may execute the reconciled data transmission module 595a to, for example, cause the processor 168 to transmit the reconciled data to a backend device (e.g., backend device 175 of FIG. 1) (block 595b). The processor 168 may execute the telematics device data and sensor device data correlation module 580a to, for example, cause the processor 168 to correlate asset data from a telematics device with sensor data from a sensor device based on a telematics device identification associated with a particular asset, location data and/or time data if and when both asset data and sensor data are available from the same asset.

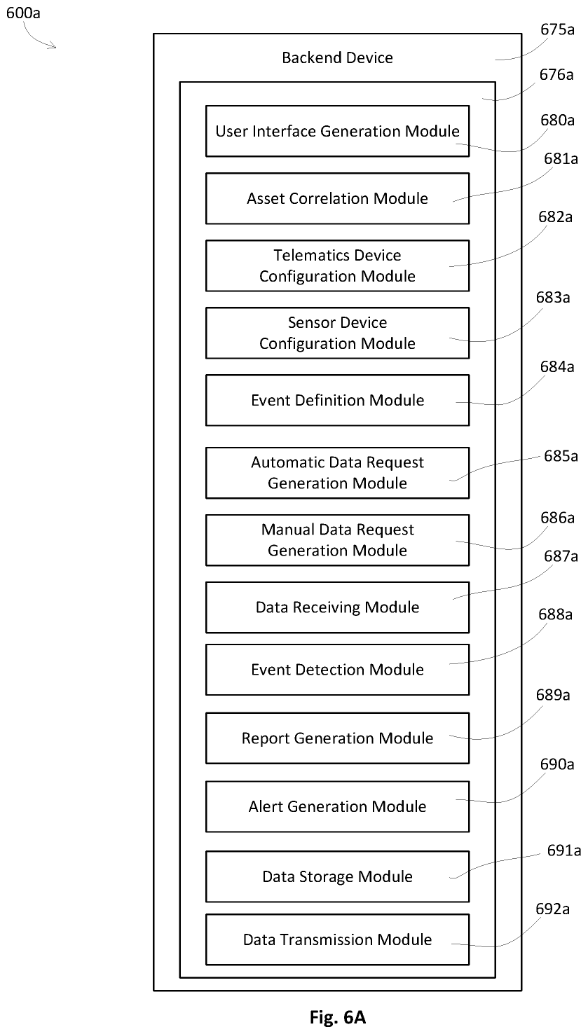

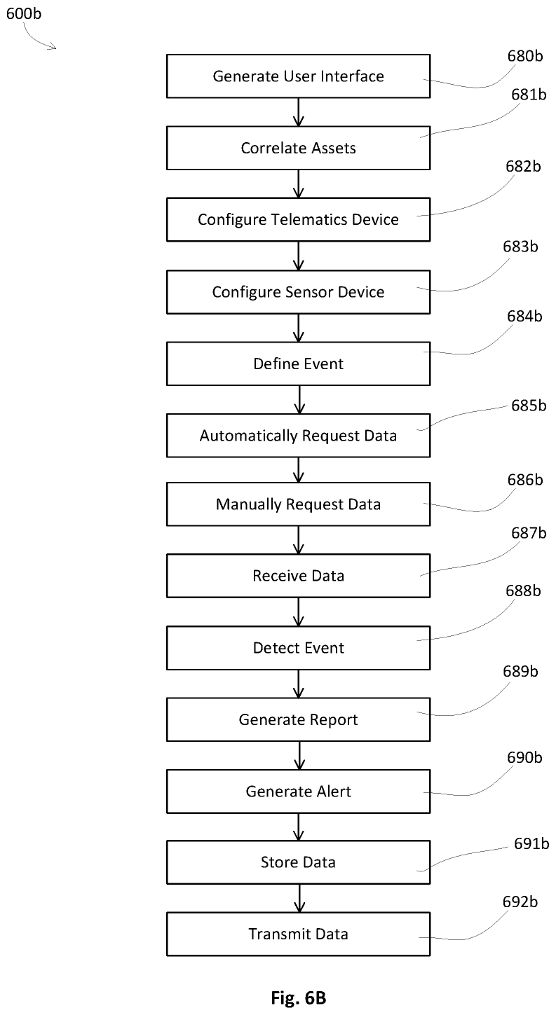

Turning to FIGS. 6A and 6B, an asset management system 600a, 600b may include a backend device 675a. The asset management system 600a, 600b may be similar to, for example, the asset management system 100 of FIG. 1. The backend device 675a may be similar to, for example, the backend device 175 of FIG. 1. In any event, the backend device 675a may include a user interface generation module 680a, an asset correlation module 681a, a telematics device configuration module 682a, a sensor device configuration module 683a, an event definition module 684a, an automatic data request generation module 685a, a manual data request generation module 686a, a data receiving module 687a, an event detection module 688a, a report generation module 689a, a report generation module 689a, an alert generation module 690a, a data storage module 691a, and a data transmission module 692a stored on a memory 676a as, for example, a set of computer-readable instructions. The modules 680a-692a may be similar to, for example, the module 181 of FIG. 1. The memory 676a may be similar to, for example, memory 180 of FIG. 1.

As an alternative to the modules 680a-692a being stored on the memory 676a as a set of computer-readable instructions, any one of, any sub-combination of, or all of the modules 680a-692a may be embodied entirely as hardware (e.g., electrical circuitry with discrete components, logic circuits, a field programmable gate array (FPGA), an application specific integrated circuit (ASIC), dedicated electrical circuits, etc.).

With further reference to FIG. 6B, a processor (e.g., processor 182 of FIG. 1) may execute the user interface generation module 680a to, for example, cause the processor 182 to generate a user interface on a display device (e.g., display device 184 of FIG. 1) (block 680b). The processor 182 may execute the asset correlation module 681a to, for example, cause the processor 182 to correlate at least one asset (e.g., assets 101-130 of FIG. 1, assets 207a, 208a of FIG. 2A, or asset 208b of FIG. 2B) with an asset management system (e.g., asset management system 100 of FIG. 1) in response to a user asset/asset management system correlation input via the user interface (block 681b).

The processor 182 may execute the telematics device configuration module 682a to, for example, cause the processor 182 to configure at least one telematics device (e.g., telematics device 155 of FIG. 1, telematics device 255a of FIG. 2A, or telematics device 355a of FIG. 3A) in response to a user telematics device configuration input via the user interface (block 682b). For example, the processor 182 may execute the telematics device configuration module 682 to assign a telematics device identification to a particular telematics device and/or to associate the particular telematics device with a particular asset 101-130. The processor 182 may execute the sensor device configuration module 683a to, for example, cause the processor 182 to configure at least one sensor device (e.g., sensor device 145 of FIG. 1, sensor devices 245a of FIG. 2A, sensor device 245b of FIG. 2B, or sensor device 445a of FIG. 4A) in response to a user sensor device configuration input via the user interface (block 683b).

The processor 182 may execute the telematics device configuration module 682a and/or the sensor device configuration module 683a to, for example, cause the processor 182 to associate a sensor device and telematics device by coupling a device ID, location data and time data of the telematics device and the sensor device when in an automated mode. The processor 182 may execute the telematics device configuration module 682a and/or the sensor device configuration module 683a to, for example, cause the processor 182 to associate asset data from a telematics device and sensor data from sensor device when the system 100 is in automated mode or when the system 100 is initiated by user.

The processor 182 may execute the event definition module 684a to, for example, cause the processor 182 to define at least one event in response to a user event definition input via the user interface (block 684b). For example, the processor 182 may execute the event definition module 684a to, for example, cause the processor 182 to enable a user to define events such as speeding, sudden acceleration, sudden braking, not driving in the lane, making unnecessary lane changes, driving too closely to the vehicle in front, an accident, filling fuel tank, a time zone change, a state line crossing.

The processor 182 may execute the automatic data request generation module 685a to, for example, cause the processor 182 to automatically generate a request for data (e.g., telematics device data and/or sensor device data) in response to, for example, the processor 182 determining that an event has occurred (blocks 685b, 688b). The processor 182 may execute the manual data request generation module 686a to, for example, cause the processor 182 to generate a request for data (e.g., telematics device data and/or sensor device data) in response to a user data request input via the user interface (block 686b). The processor 182 may execute the data receiving module 687a to, for example, to cause the processor 182 to receive data (e.g., telematics device data and/or sensor device data) in response to the processor 182 generating a request for data (blocks 685b, 686b, 687b).

The processor 182 may execute the data receiving module 687a to, for example, cause the processor 182 to receive data from a sensor 150, such as, a camera collecting video, a LIDAR sensor collecting point cloud data, a RADAR sensor collecting distances to objects nearby an asset, or a counter that counts the number of passengers as they come in and out of the vehicle. The processor 182 may execute the data receiving module 687a to, for example, cause the processor 182 to enable a user to request corresponding sensor data from a sensor device based on a device ID, location data, and/or time data.

The processor 182 may execute the event detection module 688a to, for example, cause the processor 182 to detect at least one event in response to, for example, the processor comparing the telematics device data and/or the sensor device data to a defined event (block 688b). The processor 182 may execute the report generation module 689a to, for example, cause the processor 182 to generate a report (e.g., an asset tracking report, an asset maintenance report, an asset event report, an hours of service report, an asset accident report, an operator safety report, etc.) based upon the telematics device data and/or the sensor device data (block 689b). The processor 182 may execute the alert generation module 690a to, for example, cause the processor 182 to generate an alert (e.g., an asset operator alert, an asset driver alert, etc.) based upon the telematics device data and/or the sensor device data and/or detection of a defined event (block 690b).

The processor 182 may execute the report generation module 689a to, for example, cause the processor 182 to generate a report events per vehicle or driver in a detailed form or in a summary form based upon the telematics device data and/or the sensor device data (block 689b). The processor 182 may execute the alert generation module 690a to, for example, cause the processor 182 to generate an alert a user with events based on user defined criteria (block 690b). The processor 182 may execute the alert generation module 690a to, for example, cause the processor 182 to generate an alert (e.g., an email/SMS, an instant message, a text message, etc.) to a user when the processor 182 detects that an event has happened.

The processor 182 may execute the data storage module 691a to, for example, to cause the processor 182 to store telematics device data, sensor device data, report data, alert data, etc. in a memory (e.g., an asset management database 183 of FIG. 1) (block 691b). The processor 182 may execute the data transmission module 692a to, for example, cause the processor 182 to transmit telematics device data, sensor device data, event data, report data, alert data, etc. to at least one telematics device (e.g., telematics device 155 of FIG. 1, telematics device 255a of FIG. 2A, or telematics device 355a of FIG. 3A), at least one sensor device (e.g., sensor device 145 of FIG. 1, sensor devices 245a of FIG. 2A, sensor device 245b of FIG. 2B, or sensor device 445a of FIG. 4A), or at least one remote device (e.g., remote device 165 of FIG. 1 or remote device 565a of FIG. 5A) (block 692b).

An asset management system 100 may be configured to perform truck management including, for example, an electronic logging device, hours of service, driver performance, driver communications, fuel management, fleet safety, dry van trailers, trailer tracking. An asset management system 100 may be configured to perform refrigerated assets management including, for example, reefer trailers, intermodal containers, chassis, and railcars. An asset management system 100 may be configured to perform specialty fleet assets management including, for example, first responder assets, mining assets, oil assets, and gas assets.

An asset management system 100 may be configured to perform specialty fleet asset management including, for example, heavy equipment, mining equipment, agriculture equipment, oil and gas equipment, supervisor control and data acquisition (SCADA) equipment, and utilities (e.g., water, waste water, gas, electric telephone, internet, garbage collection, etc.).

An asset management system 100 may be configured as an automatic identification system (AIS) vessel identification system that may be used for collision avoidance, identification and location information. For example, a satellite AIS may be used for maritime domain awareness, search and rescue, environmental monitoring and maritime intelligence applications with buoys and vessels. An asset management system 100 may be configured with, for example, cellular telephone and satellite dual-mode network coverage. An asset management system 100 may be configured to perform government and/or military functions, emergency management functions, public safety fleet functions, etc. An asset management system 100 may be configured with internet of things (IoT) connectivity having, for example, sensor devices with IoT SIM cards. An asset management system 100 may be configured to perform vehicle routing and dispatch functions.

The processor 182 may execute the report generation module 689a to, for example, cause the processor 182 to generate a report events per vehicle or driver in a detailed form or in a summary form based upon the telematics device data and/or the sensor device data (block 689b). The processor 182 may execute the alert generation module 690a to, for example, cause the processor 182 to generate an alert a user with events based on user defined criteria (block 690b). The processor 182 may execute the report generation module 689a to, for example, cause the processor 182 to generate fuel, idling, and IFTA mileage reports. Thereby, the asset management system 100 may eliminate time spent on tedious paperwork and identify sources of unnecessary fuel costs. The processor 182 may execute the alert generation module 690a to, for example, cause the processor 182 to generate idling alerts to notify an operator when drivers are idling in excess. The processor 182 may execute the report generation module 689a to, for example, cause the processor 182 to generate fuel reports and automatically email the report to an operator, for example, each Friday so operator may review last week's fuel activity without leaving an associated email inbox. The processor 182 may execute the report generation module 689a to, for example, cause the processor 182 to generate safety and hours of service reports that may allow an operator to quickly identify and coach for safety or compliance violations. The processor 182 may execute the alert generation module 690a to, for example, cause the processor 182 to easily customize alerts to notify an operator, for example, when a driver is speeding. The processor 182 may execute the report generation module 689a to, for example, cause the processor 182 to use an HOS report to see if drivers are approaching a compliance violation. The processor 182 may execute the report generation module 689a to, for example, cause the processor 182 to time on site reports. The processor 182 may execute the alert generation module 690a to, for example, cause the processor 182 to generate geofence alerts. Thereby, an operator may get greater visibility into driver behavior and efficiency, or may get notified when drivers or assets arrive at a given location with geofence alerts and see how much time they spend there with the time on site report.

The processor 146 may execute the asset data receiving module 365a to, for example, cause the processor 146 to receive asset data from a vehicle's diagnostic port to give an operator visibility into vehicles and equipment. Accordingly, the processor 182 may execute the alert generation module 690a to, for example, cause the processor 182 to generate vehicle fault code alerts, unsafe DVIR alerts, and preventative maintenance alerts to help an operator address issues right when the issues happen. An asset management system 100 may enable an operator to instantly review collisions, near-misses, and distracted driving events with, for example, full high-dynamic range video footage that may be automatically uploaded to the cloud. A sensor device 145 may include a g-sensor and computer vision, and the processor 182 may label and tag events, alert drivers to high-risk behavior, and/or may send event details to fleet managers in real-time.

An asset management system 100 may improve driver behavior with a combination of in-cab voice alerts, driver rankings, and HD video-based coaching tools. A touchscreen driver application may apply elements of game design to promote safer behavior and enable rewards-based safety programs. An asset management system 100 may use video evidence to defend drivers and company from false claims and costly legal battles. Thereby, an operator may quickly investigate whether or not a driver was at a location at a specific time, and review the footage to see the full story. An asset management system 100 may with safety scorecards, trend analysis, and in-depth coaching tools, thus, may offer a powerful safety platform that saves time, ensures accountability, and guarantees results.

The processor 182 may execute the report generation module 689a to, for example, cause the processor 182 to generate a temperature report and/or a humidity report. The processor 182 may execute the alert generation module 690a to, for example, cause the processor 182 to generate a door open alert to help an operator stay FSMA compliant with insight into temperature-sensitive product conditions. The processor 182 may execute the alert generation module 690a to, for example, cause the processor 182 to set up alerts to notify you when products go out of temperature range or when a product arrives safely.

An asset management system 100 may include a real-time telematics solution with GPS tracking, WiFi, and diagnostics. An asset management system 100 may not require carrier contracts, hardware, or IT complexity. An asset management system 100 may include built-in to every GPS gateway, an internet hotspot that may eliminate the need for dedicated cellular modems, wireless routers, or carrier contracts. An asset management system 100 may work with mobile computing devices and laptops. Thereby, the asset management system 100 may include driver applications, maps and navigation, work-order management, email, and CRM. An asset management system 100 may include high-speed LTE connectivity that makes it easier for drivers and a back office to share information. With driver application, drivers can stay up to date with changes in routes, deliveries, and more, and the drivers can instantly submit paperwork on the go.

An asset management system 100 may include sensor devices 145 with, for example, internet-connected high-definition cameras with computer vision. An asset management system 100 may provide live and historical temperature, cargo, and equipment monitoring. An asset management system 100 may include real-time GPS asset tracking with live vehicle location tracking, trip histories, geofence alerts, trailer tracking with theft detection, utilization reporting, and cargo and temperature status. An asset management system 100 may include safety and/or dash cameras with distracted driving detection, in-cab voice coaching, and automatic incident upload. An asset management system 100 may include routing and messaging with real-time route tracking, historical performance analysis, and two-way messaging. An asset management system 100 may include document upload with photos, centralized record-keeping, proof of delivery, and fuel usage information. An asset management system 100 may include fleet maintenance with fault code monitoring, paperless DVIRs, and usage-based maintenance reports. An asset management system 100 may include a WiFi hotspot with in-cab WiFi and cellular data included for any mobile application or mobile device. An asset management system 100 may be ELD compliant with a FMCSA-listed ELD.

An asset management system 100 may include a sensor device 145 with artificial intelligent dash cams that may analyze a road and driver behavior in real-time. An asset management system 100 may send instant alerts to drivers and actionable insights to managers. An asset management system 100 may include AI dash cameras with artificial intelligence and computer vision to detect, for example, near-misses, road signs, and high-risk driver behavior. An asset management system 100 may provide visibility into distracted driving and near-misses and may enable instant review of collisions, near-misses, and distracted driving events with full HD 1080p footage that may be automatically uploaded to the cloud. Using a g-sensor and computer vision, an asset management system 100 may label and tag events, alerts to drivers in regard to high-risk behavior, and may send event details to fleet managers in real-time. An asset management system 100 may improve driver behavior with a combination of in-cab voice alerts, driver rankings, and HD video-based coaching tools. A touchscreen driver application may apply elements of game design to promote safer behavior and enable rewards-based safety programs.

An asset management system 100 may enable an operator to investigate complaints and exonerate drivers. An asset management system 100 may use video evidence to defend drivers and a company from false claims and costly legal battles. For example, an operator may quickly investigate whether or not your driver was at a location at a specific time, and review the footage to see the full story. An asset management system 100 may include standardize incident review and driver training—even across large fleets—with accountability and workflow tools. An asset management system 100 may identify risky driving practices like distracted driving and measure changes in a safety culture over time with driver scorecards and trend reports. An asset management system 100 may ensure consistent coaching of all drivers—no matter the location, supervisor or time. For example, dash cameras may offer in-cab voice coaching for real-time feedback, and a dashboard may provide step-by-step coaching workflows for safety managers. An asset management system 100 may protect a fleet against false claims, accelerate auto insurance payouts, decrease insurance premiums, and reduce accident-related costs—all while improving the safety of employees. An asset management system 100 may enable driver safety as one part of a complete platform. For example, by combining real-time GPS tracking, sensor data, and powerful reporting tools, an asset management system 100 may enable fleet managers of all size fleets to optimize equipment, driver, and operational performance.

An asset management system 100 may provide transit fleets with enhance safety, security and customer experience with, for example, an interior camera that may monitor activity within vehicles, an external camera that capture all angles outside of vehicles, a video recorder that may store up to 30 days of footage, a vehicle gateway that may track vehicles with real-time GPS, a dual-facing dash cam that may review road and driver-facing footage. An asset management system 100 may capture all activity inside vehicles, confidently record continuous activity to enhance safety, prevent false claims, and improve customer experience. An asset management system 100 may include unlimited video uploads and 30 days of local storage that may make it easy to find and review video and image footage. An asset management system 100 may manage routes for trucks, buses, delivery vehicles, and more. Instead of manually calling drivers to see where they are, the asset management system may, for example, instantly track vehicle location, route progress, and late or missed stops.

An asset management system 100 may allow parents, customers, and outside stakeholders track route progress and receive alerts automatically. Authorized users can anticipate arrivals or delays, which improves customer service, reduces calls, and can become a differentiator for a business.

An asset management system 100 may improve customer communication and operational efficiency with real-time route tracking, automatic ETA alerts, and instant route updates. An asset management system 100 may improve planned versus actual route performance with real-time GPS tracking, advanced analytics, and intuitive reports. An asset management system 100 may adapt on-the-go. For example, dispatchers can easily re-route vehicles remotely and send messages to drivers (or an entire fleet) using the asset management system 100. An asset management system 100 may identify trends in route performance at a glance, may quickly compare planned vs. actual performance, drill into individual route histories. A planned vs. actual report may, for example, identify trends in planned vs actual performance, to improve routes and/or make the best use of vehicles. An asset management system 100 may include a combination of wireless sensor devices 145 and instant alerts that may provide visibility and control of an entire operation.

An asset management system 100 may include a reefer management solution that may monitor temperatures in-transit to prevent product spoilage and rejected deliveries, and may provide automated, continuous temperature logging that may eliminate manual recordkeeping and may provide temperature records on-demand. An asset management system 100 may provide temperature data and proof of delivery (POD) documents, and may improve customer service with more predictable delivery times. An asset management system 100 may include automatic alerts that notify users when temperature is out-of-range to avoid spoilage.

An asset management system 100 may eliminate yard hunts, optimize yard and dock operations, reduce dwell time, and simplify inventory management An asset management system 100 may identify underutilized trailers and may grow a business without making new trailer investments. An asset management system 100 may provide real-time “helicopter view” aids that may aid law enforcement in recovery of assets and/or cargo. An asset management system 100 may detect and may facilitate recover of stolen equipment by, for example, geofence alerts to identify and mitigate theft and unauthorized use An asset management system 100 may track usage and engine hours for more accurate billing and deployment.

This detailed description is to be construed as exemplary only and does not describe every possible embodiment, as describing every possible embodiment would be impractical, if not impossible. One could implement numerous alternate embodiments, using either current technology or technology developed after the filing date of this application.

What is claimed is:

1. An asset management system, the system comprising:
a telematics device communicatively coupled to an asset, wherein the telematics device is configured to receive asset data, asset location data, and asset time data;
a sensor device configured to receive sensor data, sensor location data, and sensor time data; and
a remote device communicatively coupled to the telematics device and the sensor device, wherein the remote device is configured to receive the asset data, the asset location data, the asset time data from the telematics device, wherein the remote device is configured to receive the sensor data, the sensor location data, and the sensor time data from the sensor device independent from the telematics device, and wherein the remote device is configured to correlate the asset data with the sensor data based on the asset location data, the asset time data, the sensor location data, and the sensor time data.

2. The system of claim 1, wherein the remote device is configured to compare the asset data with the sensor data.

3. The system of claim 2, wherein the remote device is configured to verify the asset data based on the comparison of the asset data with the sensor data.

4. The system of claim 2, wherein the remote device is configured to verify the sensor data based on the comparison of the asset data with the sensor data.

5. The system of claim 1, wherein the remote device is configured to reconcile the asset data with the sensor data.

6. The system of claim 1, wherein the remote device is configured to reconcile the sensor data with the asset data.

7. The system of claim 1, wherein the asset data is representative of at least one of: asset body controller data, asset engine control unit history, asset air supply pressure, asset fuel consumption, asset trip information, asset speed, asset cruise control status, asset manual operation mode status, asset autonomous operation mode status, asset engine cooling fan drive status, asset wheel speed, asset service indication, asset transmission control unit history, asset body control unit history, asset driver door status indicator, asset passenger door indicator, asset engine oil level, asset engine oil pressure, asset engine idle operation, asset turbocharger status, asset air start pressure, asset steering wheel angle, an asset accelerometer, asset pitch, asset yaw data, asset travel distance, asset idle shutdown, asset engine hours, asset engine revolutions per minute, asset operation hours, asset direction heading, asset weight, asset cruise control speed setting, asset engine temperature, asset power takeoff information, asset fuel economy, asset tire condition, asset ambient conditions, asset inlet air condition, asset exhaust condition, asset electrical power condition, asset transmission fluid level, asset transmission fluid pressure, asset brake information, asset engine coolant level, asset engine coolant pressure, asset odometer reading, asset identification number, asset crankcase pressure, asset barometric pressure, asset interior temperature, asset air inlet temperature, road surface temperature, asset particulate trap inlet pressure, asset boost pressure, asset intake manifold temperature, asset air inlet pressure, asset air filter differential pressure, asset exhaust gas temperature, asset coolant filter differential pressure, asset instantaneous fuel economy, asset average fuel economy, asset fuel temperature, asset turbo oil temperature, asset total fuel use, asset trip fuel use, asset injector metering rail pressure, asset injection control pressure, asset percent fan speed, asset engine-percent torque demand, asset actual engine-percent torque, asset accelerator position, asset percent load at current speed, asset brake position, asset clutch position, or asset water in fuel.

8. The system as in claim 1, wherein the asset time data is representative of at least one of: an asset time zone, an asset time of day, an asset day of a calendar year, or an asset calendar year, and wherein the sensor time data is representative of at least one of: a sensor time zone, a sensor time of day, a sensor day of a calendar year, or a sensor calendar year.

9. The system as in claim 1, wherein the asset location data is representative of at least one of: an asset geographic location, an asset longitudinal location, an asset latitudinal location, or an asset elevation location, and wherein the sensor location data is representative of at least one of: a sensor geographic location, a sensor longitudinal location, a sensor latitudinal location, or a sensor elevation location.

10. The system as in claim 1, wherein the sensor device includes at least one of: a processor, a memory, a communication interface, an antenna, a digital image sensor, a video camera, a door position sensor, a fuel level sensor, a temperature sensor, a temperature control unit status sensor, a humidity sensor, a humidity control unit status sensor, a moisture sensor, a moisture control unit status sensor, a pressure sensor, a pressure control unit status sensor, a light detection and ranging (LIDAR) sensor, a radar sensor, an ultra-sonic sensor, a weight sensor, a distance sensor, an occupancy sensor, a length sensor, an occupancy sensor, or a light sensor.

11. A computer-implemented method of managing an asset, the method comprising:
receiving, at a processor of a telematics device, telematics device data in response to the processor of the telematics device executing a telematics device data receiving module, wherein the telematics device data is representative of: asset data, asset location data, and asset time data, from a communicatively coupled asset;
receiving, at a processor of a sensor device, sensor device data in response to the processor of the sensor device executing a sensor device data receiving module, wherein the sensor device data is representative of: sensor data, sensor location data, and sensor time data;
receiving, at a processor of a remote device, the telematics device data from the telematics device in response to the processor of the remote device executing a remote device telematics data receiving module, wherein the remote device is communicatively coupled to the telematics device;
receiving, at the processor of the remote device, the sensor device data from the sensor device, in response to the processor of the remote device executing a remote device sensor data receiving module, wherein the remote device is communicatively coupled to the sensor device, and wherein the sensor device data is independent from the telematics device data; and
correlating, using the processor of the remote device, the asset data with the sensor data, based on the asset location data, the asset time data, the sensor location data, and the sensor time data, in response to the processor of the remote device executing a data correlation module.

12. The method of claim 11, further comprising:
comparing, using the processor of the remote device, the asset data and the sensor data in response to the processor of the remote device executing a data comparison module.

13. The method of claim 12, further comprising:
verifying, using the processor of the remote device, the asset data, based on the comparison of the asset data with the sensor data, in response to the processor of the remote device executing a data verification module.

14. The method of claim 12, further comprising:
verifying, using the processor of the remote device, the sensor data, based on the comparison of the asset data with the sensor data, in response to the processor of the remote device executing a data verification module.

15. The method of claim 11, further comprising:
reconciling, using the processor of the remote device, the asset data with the sensor data in response to the processor of the remote device executing a data reconciliation module.

16. The method of claim 11, further comprising:
reconciling, using the processor of the remote device, the sensor data with the asset data in response to the processor of the remote device executing a data reconciliation module.

17. A computer-readable medium storing computer-readable instructions that, when executed by a processor, causes the processor to manage an asset, the computer-readable medium comprising:
a telematics device data receiving module that, when executed by a processor of a telematics device, causes the processor of the telematics device to receive telematics device data from a communicatively coupled asset, wherein the telematics device data is representative of: asset data, asset location data, and asset time data;
a sensor device data receiving module that, when executed by a processor of a sensor device, causes the processor of the sensor device to receive sensor device data from a sensor device, wherein the sensor device data is representative of: sensor data, sensor location data, and sensor time data;
a remote device telematics data receiving module that, when executed by a processor of a remote device, causes the processor of the remote device to receive telematics device data from the telematics device, wherein the remote device is communicatively coupled to the telematics device;
a remote device sensor data receiving module that, when executed by the processor of the remote device, causes the processor of the remote device to receive the sensor device data from the sensor device, wherein the remote device is communicatively coupled to the sensor device, and wherein the sensor device data is independent from the telematics device data; and
a data correlation module that, when executed by the processor of the remote device, causes the processor of the remote device to correlate the asset data with the sensor data, based on the asset location data, the asset time data, the sensor location data, and the sensor time data, to generate correlated data.

18. The computer-readable medium of claim 17, further comprising:
a data comparison module that, when executed by the processor of the remote device, causes the processor of the remote device to compare the asset data and the sensor data.

19. The computer-readable medium of claim 18, further comprising:
a data verification module that, when executed by the processor of the remote device, causes the processor of the remote device to verify the asset data, based on the comparison of the asset data with the sensor data.

20. The computer-readable medium of claim 18, further comprising:
a data verification module that, when executed by the processor of the remote device, causes the processor of the remote device to verify the sensor data, based on the comparison of the asset data with the sensor data.

21. The computer-readable medium of claim 17, further comprising:
a data reconciliation module that, when executed by the processor of the remote device, causes the processor of the remote device to reconcile the asset data with the sensor data.

22. The computer-readable medium of claim 17, further comprising:
a data reconciliation module that, when executed by the processor of the remote device, causes the processor of the remote device to reconcile the sensor data with the asset data.

23. The computer-readable medium of claim 17, further comprising:
a data transmission module that, when executed by the processor of the remote device, causes the processor of the remote device to transmit at least one of: the telematics device data, the sensor device data, or the correlated data, to a processor of a backend device.

24. The computer-readable medium of claim 23, further comprising:
an event definition module that, when executed by the processor of the backend device, causes the processor of the backend device to generate a defined event based on a user input.

25. The computer-readable medium of claim 24, further comprising:
an event detection module that, when executed by the processor of the backend device, causes the processor of the backend device to detect an event based on a comparison of the defined event with at least one of: the telematics device data, the sensor device data, or the correlated data.
